(19) United States
(12) Patent Application Publication
(10) Pub. No.: US 2019/0339404 A1
(43) Pub. Date: Nov. 7, 2019

(54) SEISMIC SOURCE OPERATION AT LOW FREQUENCIES

(71) Applicant: ION Geophysical Corporation, Houston, TX (US)

(72) Inventor: Curt Schneider, Houston, TX (US)

(21) Appl. No.: 16/400,609

(22) Filed: May 1, 2019

Related U.S. Application Data
(60) Provisional application No. 62/666,057, filed on May 2, 2018.

(51) Int. Cl. G01V 1/137; G01V 1/38

(52) U.S. Cl. CPC G01V 1/137; G01V 1/3861

(57) ABSTRACT

An example system includes a first seismic source configured to emit seismic energy by generation of a first air bubble into the seismic medium at a first time, and a second seismic source spaced a predefined distance from the first seismic source. The second seismic source is configured to emit seismic energy by generation of a second air bubble into the seismic medium at a second time after the first time. The seismic energy has a low frequency characteristic.

### CROSS REFERENCE TO RELATED APPLICATIONS

This application claims priority to U.S. Provisional Application No. 62/666,057, filed May 2, 2018, entitled “Low Frequency Seismic Source,” which is incorporated by reference herein, in its entirety and for all purposes.

### BACKGROUND

This application relates to geophysical exploration and seismic data acquisition, including seismic source technologies. Applications include, but are not limited to, marine seismic surveys, seismic data acquisition, and geophysical image generation.

In marine seismic exploration, a streamer array is typically towed behind a marine vessel. A series of hydrophones (or pressure sensors) and motion sensors (or accelerometers) are deployed along the streamers, and configured to sense seismic energy propagating through the water column. Alternatively, the sensors can be deployed along ocean-bottom cables, or in autonomous seismic sensor nodes distributed on the seabed, or suspended at depth below the surface.

The seismic energy is typically produced by seismic sources configured to generate periodic bursts of seismic energy. The energy propagates down through the water column in the form of acoustic waves, which can penetrate the seafloor to reflect from subsurface structures. The sources can be deployed by the same seismic vessel that tows the streamers, or by designated source vessels.

The reflected seismic energy is detected at the seismic sensor locations, in the form of an upward-propagating seismic wavefield. The sensors produce seismic data by sampling the seismic wavefield, and the data are processed to generate seismic images of the underlying structures. Suitable methods of signal conditioning are described in U.S. Pat. No. 6,539,308 to Monk et al. and U.S. Pat. No. 8,830,766 to Lambert et al., each of which is incorporated by reference herein.

### SUMMARY

This application is directed to a seismic source system configured for operation at low frequencies, and methods of operation thereof, as described herein.

### BRIEF DESCRIPTION OF THE DRAWINGS

FIG. 1 is a schematic illustration of a representative marine seismic survey in accordance with embodiments of the disclosure.

FIG. 2 is a plot illustrating zero hertz receiver ghost notch at different cable depths in accordance with embodiments of the disclosure.

FIG. 3 is an isometric view of a low-frequency seismic source in accordance with embodiments of the disclosure.

FIGS. 4A-4C include various views of a cluster source assembly in accordance with embodiments of the disclosure.

FIG. 5 is a schematic illustration of a first towing configuration for low-frequency seismic sources in accordance with embodiments of the disclosure.

FIG. 6 is a schematic illustration of a second towing configuration for low-frequency seismic sources in accordance with embodiments of the disclosure.

FIG. 7 is a two-dimensional view showing a physical arrangement of seismic sources in a survey system, in accordance with embodiments of the disclosure.

### DETAILED DESCRIPTION

In this disclosure, reference is made to examples and embodiments of the invention. It should be understood that the claims are not limited to these specifically described examples, and any combination of the following features and elements is contemplated to implement and practice the invention, as recited in the claims, and as described in terms of the embodiments disclosed herein.

Although the various features of the invention may provide certain advantages over the prior art, and over other possible solutions to the problems addressed herein, whether or not such advantages are achieved does not limit the invention to a given embodiment. The following aspects, features and advantages of the invention are merely illustrative, and are not to be construed as features or limitations of the claims, except where explicitly recited therein. References to “the invention” shall not be construed as a generalization of any of the subject matter that is disclosed, and do not limit the claims except where the relevant features are expressly stated.

### Noise

Noise is a substantial consideration in seismic surveys. Noise sources include swell noise and wave noise from the sea surface, and towing noise generated by the streamer cables traveling through the water column. Noise propagates both through the water column, and also along the streamers.

Noise contributions can sometimes be reduced with a combination of temporal and spatial filtering. Temporal filtering is accomplished by discrete digital sampling of the sensor signals, and weighting the samples acquired as a function of time. Analog filters can be used to prevent aliasing of signals at frequencies greater than half the sample rate.

Spatial samples are typically formed by group-summing individual sensor outputs, so that noise propagating along the length of the streamer is attenuated. Noise components that propagate orthogonal to the streamer axis, however, may not be affected.

The acoustic impedance ρc is the product of the density p of the water column (or other acoustic medium), and the speed c of acoustic wave propagation in the medium. Acoustic energy reflects when there is a change in the impedance, not only due to the subsurface structures but also when the sound waves encounter the water/air interface along the upper surface boundary, and at the ocean bottom. Energy that is not reflected is transmitted (or refracted) beyond the boundary, as defined between the two regions of different acoustic impedance.

Acoustic waves propagate through water and other media in the form of pressure waves or compression waves, which induce particle motion in the direction of propagation. At a planar interface between two different homogenous media, the acoustic waves reflect at an angle equal to the angle of incidence θ₁, and refract at angle θ₂ given by

sin θ₂=c₂ sin θ₁/c₁ [1]

as defined for acoustic waves travelling from a first medium (1) with propagation velocity c₁ to a second medium (2) with propagation velocity c₂. If the incident angle θ₁ is zero, then the reflected energy propagates back through the first medium along the same incident path, and the refracted waves propagate forward through the second medium at angle θ₂=0.

For an incident angle θ₁ of zero and no conversion to shear energy, the reflection coefficient is:

$${R}_{pp} = \frac{{ρ}_{2} {c}_{2} - {ρ}_{1} {c}_{1}}{{ρ}_{2} {c}_{2} + {ρ}_{1} {c}_{1}} \qquad [ 2 ]$$

The sea surface can be a near perfect reflector of sound energy, with a reflection coefficient of approximately 1 at the water-air interface (Rₚₚ≈1). After reflecting from the seafloor and subsurface structures of interest, the acoustic energy thus propagates upward through the water column to the surface, and reflects back again down toward the sensors.

The sensors detect a ghost response from the downward-propagating acoustic waves reflected from the sea surface. The “ghost” signal arrives delayed in time from the upward-propagating wavefield, and is reversed in polarity. The downward-propagating ghost wave adds to the upward-propagating signal, affecting reconstruction of the seismic image. The ghost reflection can also travel back down to the seafloor (or other interface), and then reflect back upward to produce additional reflected signals, commonly referred to as multiples.

For a vertically traveling pressure wave, the ghost produces one or more “notches” in the frequency spectrum. In some examples, a notch may be produced at a zero hertz frequency. The zero-hertz notch location may be fixed independent of streamer depth. In addition, the ghost may further produce one or more additional notches in the frequency spectrum based on streamer depth. For example, the ghost may produce a notch at a frequency f_{notch}=d2d, where c is the acoustic velocity and d is the streamer depth. For typical streamer depths don the order of 10 m, the notch frequency is f_{notch}˜75 Hz; thus, a frequency response extending beyond about 100 Hz can be required for high-quality seismic image resolution.

Because the notch frequency is inversely proportional to the tow depth, streamers can be towed at shallower depths to improve resolution. Shallow depths can problematic, however, due to noise from the sea surface interfering with the seismic signal. These effects may worsen as the weather deteriorates, sometimes causing the crew to discontinue operations until conditions improve. Reducing ghost-notch effects enables towing at greater depths, farther from surface disturbances.

Ocean bottom systems can reject ghosts and multiples by a technique commonly known as p-z summation. In an acoustic wave, the pressure p is a scalar, while the particle velocity u is a vector quantity. A hydrophone with positive omni-directional response records the seismic acoustic wave pressure p, and a geophone or accelerometer records the velocity u, including the vertical component u_{z}, which has a positive response to up-going signals and a negative response to down-going signals.

In p-z summation, the velocity signal is scaled by the acoustic impedance ρc of the seawater (or other acoustic medium), and added to the pressure signal. A single-axis sensor can also be used, e.g., by scaling to account for the change in sensitivity due to the off-axis arrival direction of the signal. For example, an accelerometer output signal can be integrated to obtain the velocity, or the hydrophone signal can be differentiated to spectrally match the accelerometer. This produces a compound sensor design, with full response to the upward-traveling wave and at least a partially muted response to the downward-traveling wave, in order to reject ghosts and multiples.

Techniques like p-z summation can also be applied to towed-streamer acquisition, allowing for greater tow depths with less interference from ghost-notch reflections. Streamers, however, can also experience acceleration due to towing and sea surface effects. These effects may be substantial compared to the acceleration signal from the reflected seismic wavefield, and may fall into the same spectral band of interest, along with the desired reflection response.

The towing speed of the streamer can also be perturbed when the tow vessel encounters ocean waves, which typically introduce a yawing motion as well. Much of the vessel's acceleration energy can be attenuated by deploying the streamers with elastic tow lines, but some of the energy can still be transmitted along the streamer cables, producing noise contributions in the seismic data.

Performance of a particle-velocity measuring system should be near the ambient noise limits. The acceleration (a) due to a planar pressure wave (e.g., from a reflected seismic signal) can be given by:

$$a = \frac{p \times 2 π f}{Z} , \qquad [ 3 ]$$

where p is the acoustic sound pressure level, f is the frequency, and Z is the acoustic impedance of the medium. The presence of secondary peaks in the acceleration signal indicates that, in some cases, the cable dynamic motion can be greater than the seismic signal to be measured. While this problem has been identified in the prior art, there remains a need for improved seismic survey techniques that produce high-fidelity sampling of the reflected seismic wavefield, with good signal-to-noise ratio down to the lowest frequencies of interest.

### Seismic Surveys

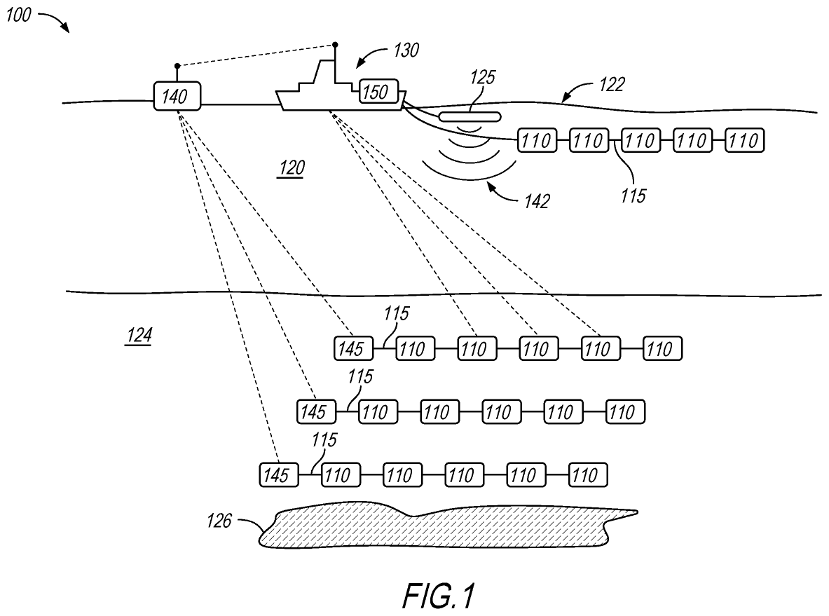

FIG. 1 is a schematic illustration of a representative seismic survey (or survey system) 100, including an array of seismic receivers or autonomous nodes 110 deployed to a water column 120 along one or more ropes or cables 115. Water column 120 extends from a top surface 122 to the ocean floor or other bottom surface 124, e.g., above a petroleum reservoir or other subsurface structure 126 of interest.

A seismic source (or source array) 125 configured for operation at low frequencies can be deployed behind seismic vessel 130, as described herein, either alone or in combination with an array of receivers 110 disposed along one or more towed cables, streamers or node lines 115, using a suitably adapted seismic survey deployment system 150. Suitable seismic vessels 130 can also be configured to deploy receivers 110 to the seabed or other bottom surface 124, e.g., with receivers 110 distributed along one or more ocean-bottom cables 115 disposed above a reservoir or other subsurface structure 126.

Receivers 110 can also be suspended at depth within water column 120, between top surface 122 and the ocean floor or seabed 124, or a combination of ocean bottom cables 115, towed receivers 110 and suspended receivers 110 can be deployed. A combination of manned, unmanned or autonomous vessels 130 can also be used for deployment, service, and recovery of the receivers 110 and sources 125, in either surface or submersible configurations. For example, a remote operated vessel or remote operated underwater vessel (ROV) may be used.

Seismic receivers and nodes 110 can be configured for communications while deployed in water column 120, for example via a termination device or transponder 145 deployed along cable 115, with either a wired or wireless (e.g., acoustic, inductive or capacitive) data connection to a seismic hub or buoy system 140. Wireless data communications can also be provided directly between individual receivers 110 and the seismic vessel 130, and between the seismic vessel 130 and one or more hub devices 140, e.g., with a global positioning satellite (GPS) system or other navigational system to determine location and timing data for receives 110. A suitably configured hub 140 or “master” node station/transponder 145 can also be provided with a high precision master clock, in order to synchronize timing information for the seismic receivers 110 disposed in the seismic array or survey system 100.

Seismic cables 115 encompass towed streamer, ocean bottom cable, and suspended cable embodiments, and suitable marine-based seismic system configurations may also include autonomous receivers or nodes 110. While references are made to a sea floor or seabed 124, moreover, in practice the claims are not limited to any particular body of water or other seismic medium 120. Rather, receivers 110 and source systems 125 may be deployed to any water or marine environment, including oceans, lakes, rivers, etc., and in other land-based or water-based seismic applications. Accordingly, use of the terms sea, seabed, sea floor, and the like should be broadly understood to encompass all bodies of water and all other seismic media 120, including subsurface, marine and land-based surfaces 124 suitable for deployment of seismic receivers 110 adapted to detect propagating seismic energy produced by low-frequency seismic sources 125.

One or more sources 125 can be configured to operate independently, or to emit seismic energy in a coordinated fashion at substantially the same time; e.g., according to a simultaneous source regime. Depending on embodiment, each source apparatus 125 may include one or more seismic source components configured to generate the seismic energy at low frequencies, as described herein, so that the seismic wavefield propagates through water column or other medium 120 in the form of acoustic waves 142.

For example, an air gun array or subarray 125 can be configured to generate acoustic waves 142 by emitting controlled blasts of compressed air, or other pneumatic, mechanical or electromechanical source components 125 can be used. A portion of the seismic waves 142 propagates down through water column 120 to penetrate the seabed 124, and reflects from a petroleum reservoir or other subsurface geological structure of interest 126. A portion of the reflected seismic energy propagates back up to the seismic receives 110 deployed along the seabed 124, or within the water column 120.

Reflections can also occur at top surface 122 and bottom surface 124 of water column 120, resulting in a combination of upward-propagating and downward-going seismic wavefield components. Deghosting can be applied to the resulting seismic data acquired by receivers 110, in order to improve image quality and resolution for geophysical exploration of the subsurface layers and other relevant geological structures 126.

### Source Performance

For airgun source systems, the bubble period T of a single element can be represented by:

$$T = \frac{{( P \times V )}^{1 / 3}}{C \times {( {P}_{0} )}^{5 / 6}} \qquad [ 4 ]$$

where C is a constant parameter, e.g., according to the Rayleigh-Willis formula. The fundamental frequency F of a single-gun source can be represented by:

$$F = \frac{C \times {( {P}_{0} )}^{5 / 6}}{{( P \times V )}^{1 / 3}} . \qquad [ 5 ]$$

Where low frequency F or high period Tare desired, or both, this implies or can be achieved by selecting suitable operational parameters including, but not limited to, high charge pressure P₀ and large gun volume V, and operation of the source at shallow depths. However, the zero hertz notch can limit the effectiveness of this approach, and should be addressed to achieve the performance improvement attainable by selecting suitable values of the pressure and volume parameters, as described in the equations, and other operational parameters of the source. For example, large volume sources may be operated in a high pressure, tri-cluster design, at suitable depth in the water column. Thus, a high pressure, high volume, single or multiple-source apparatus can be operated at suitable depth, in order to achieve desired results as described herein.

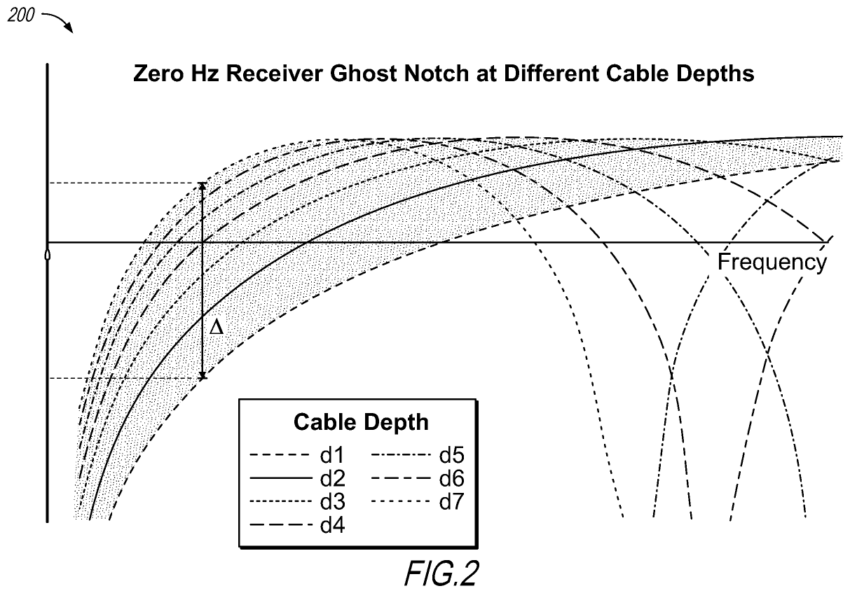

FIG. 2 is a plot 200 illustrating zero hertz receiver ghost notch at different cable depths. For example, the depths may range from about 10 m to about 40 m, and the frequencies may range from about 0 to about 25 Hz. Depending on configuration, there may be an attenuation A of about 10 dB or more between the different depths.

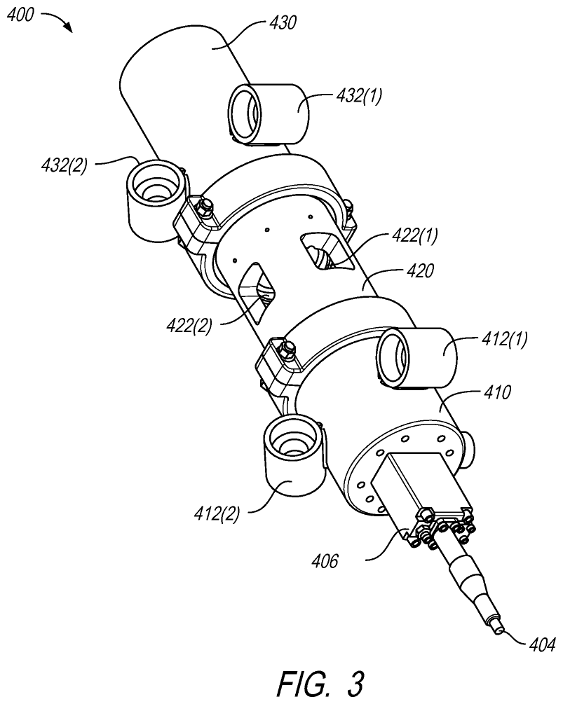

FIG. 3 is an isometric view of a seismic source device 400 in accordance with some embodiments of the disclosure. The low-frequency source 125 of FIG. 1 may implement the seismic source 400 in some embodiments. Depending on embodiment, the seismic source 400 may be provided by a commercial vendor such as BOLT Technology Corporation of Norwalk, Conn., and modified for low frequency operation by selection of relevant operating parameters as described herein.

Suitable seismic source devices 400 may comprise a double ear large volume air gun or other suitable seismic source device configuration, and may include one or more of an inlet port 404, a solenoid valve assembly 406, fire chamber 410, a main housing 420 with outlet ports 422(1)-(2), a reservoir chamber 430, mounts 412(1)-(2) and 432(1)-(2) for a cluster source assembly. The seismic source device 400 may further include an O-ring, seal, and hex nut or other mechanical fattener components. A shuttle flange can be provided, e.g., with an O-ring groove, in combination with a seal (shaft retainer), sleeve liner, seal support ring, spring, spring holder, and suitable orifice. The fire chamber can be provided as a gland type, solid design, and/or with a radiused, threaded shaft shuttle and shuttle bearing. These design options are merely representative, and vary from embodiment to embodiment. In some examples, the reservoir chamber 430 may have a volume up to approximately 2000 cu. in. In some examples, the reservoir chamber 430 may have a volume up to approximately 6000 cu. in. It is appreciated that, assuming a common target pressure (e.g., 2000 PSI or another target pressure) and a common refill air compressor capacity, a size of the reservoir chamber 430 may affect a time to refill the reservoir chamber 430 to the common pressure for a subsequent fire of the seismic source device 400. That is, using a common air compressor, it may take less time to refill a seismic source device 400 with a reservoir chamber 430 volume of 2000 cu. in. to a common pressure than it takes to fill a seismic source device 400 having a reservoir chamber 430 volume of 6000 cu. in. to the common target pressure. Thus, a maximum firing frequency of the seismic source device 400 may be dependent on the reservoir chamber 430 volume.

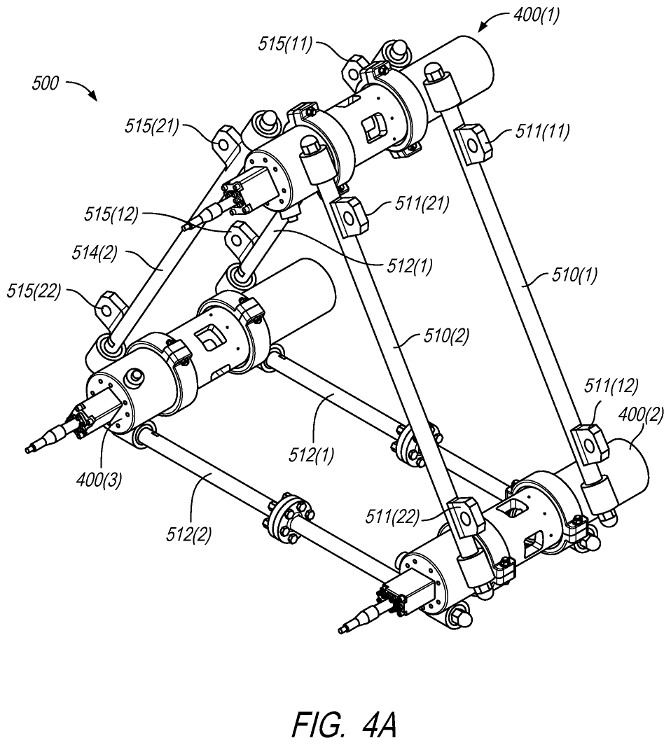

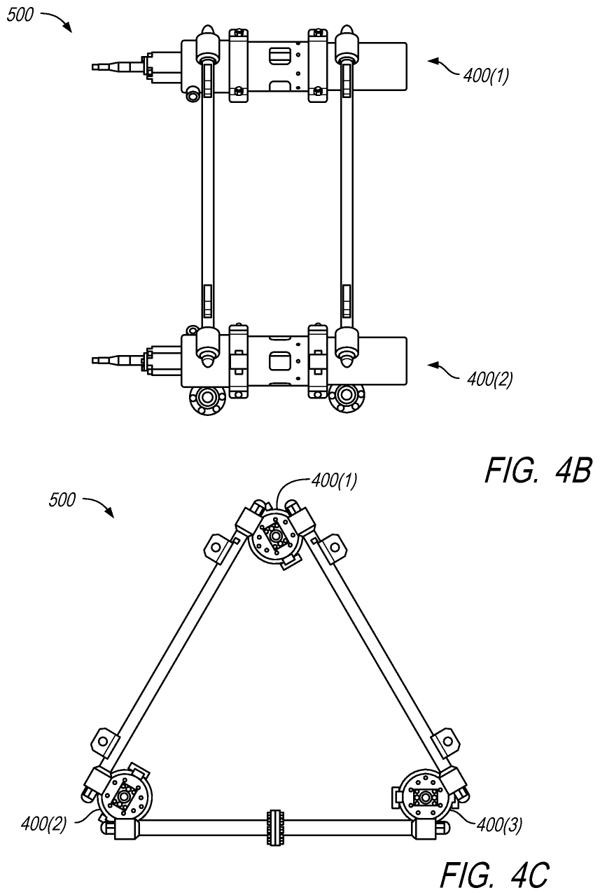

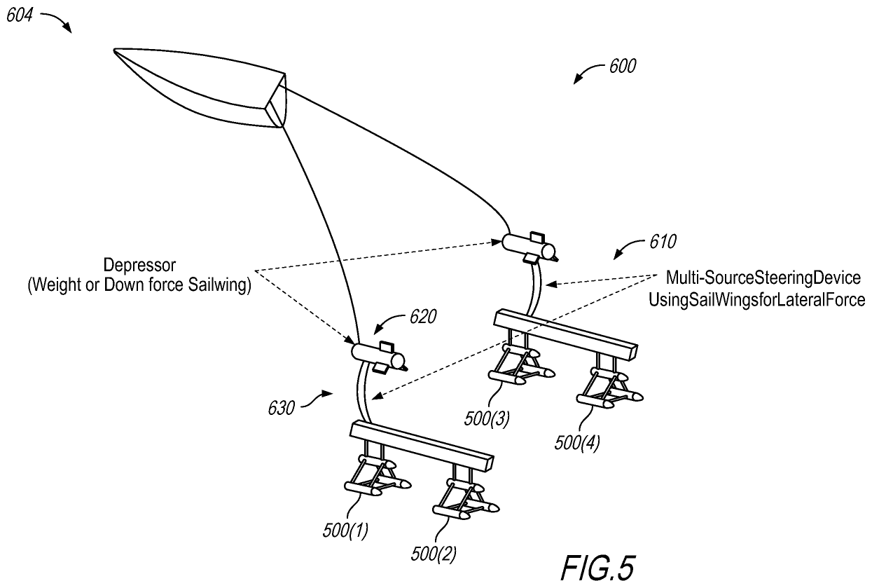

FIGS. 4A-4C include various views of a cluster source assembly 500, including seismic source devices 400(1)-(3), in accordance with some embodiments of the disclosure. FIG. 5A is an isometric view of the cluster source assembly 500, FIG. 5B is a side view of the tri-cluster source assembly 500, and FIG. 5C is an end view of the cluster source assembly 500.

FIGS. 4A-4C may include elements that have been previously described with respect to the seismic source device 400 of FIG. 3. Those elements have been identified in FIGS. 4A-4C using the same reference numbers used in FIG. 3 and operation of the common elements is as previously described. Consequently, a detailed description of the operation of these particular elements will not be repeated in the interest of brevity.

Depending on embodiment, the cluster source assembly 500 may include one or more long life air guns or other seismic source devices 400(1)-(3), one or more spreader bar kits 510(1)-(2) and 514(1)-(2) with or without tow fixtures or “ears” 511(11)-(22) and 515(11)-(22), and one or more spreader bar kits 512(1)-(2); e.g., for the cluster source assembly 500. While the cluster source assembly 500 is shown with three seismic source devices 400(1)-(3), the cluster source assembly 500 may include additional seismic source devices 400 without departing from the scope of the disclosure. Suitable suppliers include BOLT Technology of Norwalk, Conn., where the operational parameters of the seismic source devices 400(1)-(3) are modified and selected for seismic source operation at low frequencies, as described herein. A synchronizer may also be provided to synchronize firing of the seismic source devices 400(1)-(3), with suitable tow lines and umbilical lines for deploying and supplying compressed air to the seismic source devices 400(1)-(3). In some examples, the outlet ports of the seismic sources 400(1)-(3) may be oriented in different directions from one another such that the air bubbles generated when the seismic sources 400(1)-(3) are fired (e.g., activated) to travel in different directions and do not merge or frequency-lock. In some examples, the seismic source devices 400(1)-(3) may fire contemporaneously. Thus, a first of the seismic source devices seismic source devices 400(1)-(3) may emit seismic energy by generation of a first air bubble in the seismic medium in a first direction at a specified time, and a second of the seismic source devices 400(1)-(3) spaced a predefined distance from the first of the seismic source devices 400(1)-(3) may emit seismic energy by generation of a second air bubble in the seismic medium in a second direction at the specified time that is different than the first direction. Additionally, a third of the seismic source devices 400(1)-(3) spaced a defined distance from each of the first and second of the seismic source devices 400(1)-(3) may emit seismic energy by generation of a third air bubble in the seismic medium in a third direction at the specified time that is different than the first direction and different than the second direction. The seismic energy may have a low frequency characteristic (e.g., may have a frequency that is less than a predefined frequency). The first air bubble may be spaced from the second and third air bubbles without frequency locking, while generating the seismic energy in the seismic medium. The first, second, and third air bubbles may collapse to generate the seismic energy in the form of a seismic wavefield propagating through the seismic medium.

The defined distances between the seismic source devices 410(1)-(3) may be selected to reduce ghosting effects and/or zero-hertz notch effects in the seismic wavefield. Further, the seismic source devices 410(1)-(3) may be oriented relative to one another to reduce ghosting effects in seismic wavefield. In some examples, the defined distance, a relative orientation between the seismic source devices 410(1)-3, and the low frequency characteristic may be selected based on one or more of charge pressure P0, gun volume V, and operation of the source at a selected depth.

FIG. 5 is a schematic illustration of a first representative towing configuration 600 for cluster source assemblies 500(1)-(4) as described herein. FIG. 5 may include elements that have been previously described with respect to the cluster source assembly 500 of FIGS. 4A-4C. Those elements have been identified in FIG. 5 using the same reference numbers used in FIGS. 4A-4C and operation of the common elements is as previously described.

As shown in FIG. 5, the cluster source assemblies 500(1)-(4) are deployed in one or more source subarrays 610, e.g., deployed using a depressor, ballast (weight) system or downforce foil 620 and one or more steering foils 630, e.g., using one or more “SailWing” type or other steerable foil devices as described in U.S. Pat. No. 9,632,195, International patent application PCT/US2016/057344 (WO 2017/066762), U.S. patent application Ser. No. 14/959,009 (Publication No. 2016/0161622), and International patent application PCT/IB2017/000209 (WO 2017/141111), each of which is incorporated by reference herein, in the entirety and for all purposes. The towing configuration 600 is shown in FIG. 5 as being towed by a vessel 604.

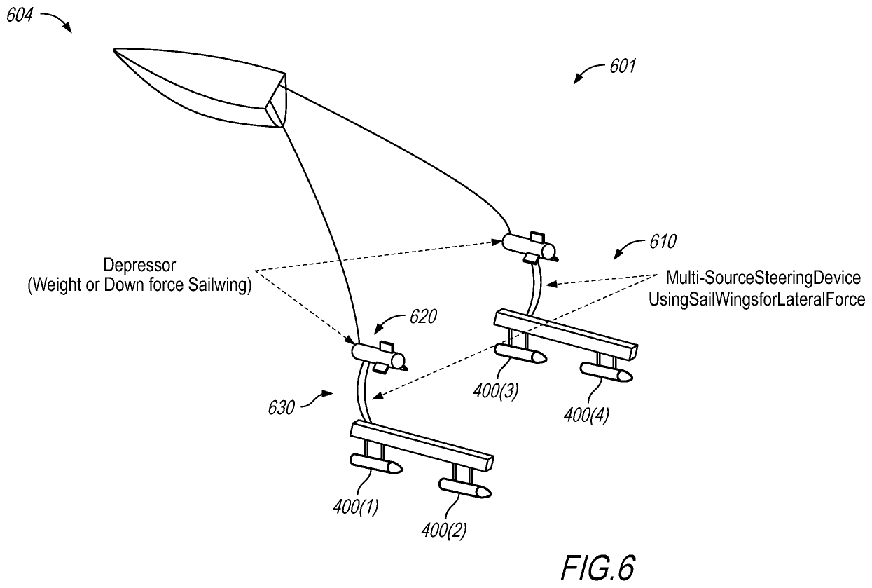

FIG. 6 is a schematic illustration of a second representative towing configuration 601 for seismic source devices 400(1)-(4) as described herein. FIG. 6 may include elements that have been previously described with respect to the seismic source device 400 of FIG. 3 and with respect to the first representative towing configuration 600 of FIG. 5. Those elements have been identified in FIG. 6 using the same reference numbers used in FIG. 3 or FIG. 5 and operation of the common elements is as previously described.

As shown in FIG. 6, the seismic source devices 400(1)-(4) are deployed in one or more source subarrays 610, e.g., deployed using a depressor, ballast (weight) system or downforce foil 620 and one or more steering foils 630. The towing configuration 601 is shown in FIG. 6 as being towed by a vessel 604. In some examples, the seismic source devices 400(1)-(4) may have a volume up to approximately 6000 cu. in. when towed in the second representative towing configuration 601.

In some examples, the source 125 of FIG. 1, the seismic source device 400 of FIG. 4, the cluster source assembly 500 of FIGS. 4A-4C, the cluster source assemblies 500(1)-(4) of FIG. 5, and/or the seismic source devices 400(1)-(4) of FIG. 6 may be deployed in a vertical orientation, e.g., at or near the water/air interface (e.g., interface defining the surface 122 of the water column 120, as shown in FIG. 1).

The described method for testing at low frequencies (e.g., 1 to 4 Hz) may improve velocity model building using full waveform inversion (FWI). The improvement in velocity model building using FWI may include using the Rayleigh-Willis equation, using a deep tow implementation to take advantage of constructive ghost energy, increase signal-to-noise ratio by firing the sources or airguns more frequently, simplifying source arrays for improved low frequency energy, or any combination of elements above.

One potential limitation in using the previously discussed Rayleigh-Willis formula to select frequency, depth, and time parameters for an airgun source arrangement and firing in a seismic sensing system is that the resulting peak bubble frequency may be limited to approximately 3.5 Hz or 285 milliseconds. As previously discussed, towing the airguns deep may result in low frequency uplift based on a depth of towing the airguns, which may provide a notched frequency spectrum with a lowest frequency lobe in a range of 1-5 Hz. However, in some embodiments, the system may be configured to create pulses on top of the base spectrum to provide additional uplift in discrete frequencies.

For example, the system may include multiple airguns located physically proximate to one another, each individual airgun may sequentially fire at constant intervals as part of a single firing sequence. As each gun fires at the constant interval, the resulting spike will synthesize with frequencies of signals generated from the single gun spectrum. That is, the firing of multiple airguns at the constant intervals may result in an uplift to the discrete frequency defined by the constant interval. In some examples, the uplift may be 10 dB or more. The constant interval/frequency may be 1 second/1 Hz, 2 seconds/0.5 Hz, or another constant interval/frequency. Using multiple airguns pulsed at constant intervals may synthesize an extended time delay between pulses and bypass a bubble period derived from the Rayleigh-Willis formula. It is appreciated that a maximum firing frequency of a single air gun may be dependent on a reservoir chamber volume, as a refill/recovery time between consecutive firings is based on the reservoir chamber volume. Thus, a tow speed and time between consecutive firing sequences may be dependent on the maximum firing frequency of a single airgun. The single airguns may be towed at depths from 0 to 150 meters.

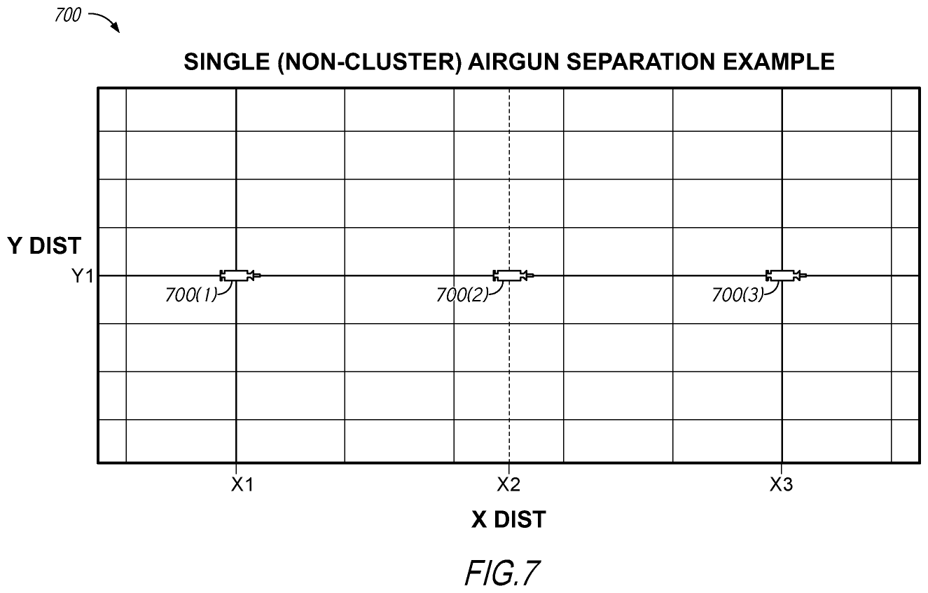

FIG. 7 a two-dimensional view of a physical arrangement of seismic sources 700(1)-(3) of a survey system 700, in accordance with embodiments of the disclosure, additional airguns may be included without departing from the scope of the disclosure. In some examples, each of the seismic sources 700(1)-(3) may implement the source 125 of FIG. 1, the seismic source device 400 of FIG. 4, the cluster source assembly 500 of FIGS. 4A-4C, one of the cluster source assemblies 500(1)-(4) of FIG. 5, the seismic source devices 400(1)-(4) of FIG. 6, or any combination thereof). In the plot 700, the first seismic source 700(1) is located at X-Y coordinate X1,Y1, the second seismic source 700(2) located at X-Y coordinate X2,Y1; and the third seismic source 700(3) located at X-Y coordinate X3,Y1.

While FIG. 7 depicts the system 700 having three seismic sources 700(1)-(3), more than three seismic sources may be included without departing from the scope of the disclosure. The seismic sources 700(1)-(3) may be spaced apart at predefined distances.

In some examples, the distance between X1 and X2 is equal to a distance between X2 and X3. In other examples, the X1-X2 distance is different than the X2-X3 difference. For example, the seismic sources 700(1)-(3) may be spaced apart anywhere from 1 to 10 meters. In some examples, the seismic sources 700(1)-(3) may be spaced apart at a distance of 5 meters.

The physical arrangement may vary from depicted without departing from the scope of the disclosure. For example, rather than being arranged in a line in the X direction, the seismic sources 700(1)-(3) may be arranged in a line in the Y direction, or may be arranged to form vertices of a triangle (or other shape when more than three seismic sources are included in the system 700).

The seismic sources 700(1)-(3) may operate at any pressure from 1000 to 3000 PSI. In some examples, the seismic sources 700(1)-(3) may operate at approximately 2000 PSI. The outlet ports of the seismic sources 700(1)-(3) may be oriented in the same direction, in some examples, or in different directions, in other examples.

The seismic sources 700(1)-(3) may be configured to pulse at constant intervals. For example, the seismic sources 700(1)-(3) may be configured to pulse relative to one another at predetermined, constant time intervals, such as 1 second intervals or 2 second intervals. For example, the seismic source 700(1) may pulse at a first time, the seismic source 700(2) may pulse at a second time that is one predetermined time interval after the first time, and the seismic source 700(3) may pulse at a third time that is one predetermined time interval after the second time. The sequence may start to repeat with a pulse from the seismic source 700(1) at a fourth time that is one predetermined time interval after the third time. The seismic sources 700(1)-(3) may be configured to pulse at other intervals without departing from the scope of the disclosure.

In some examples, the seismic sources 700(1)-(3) may each emit separate air pulse signals (e.g., bubbles) at a given depth. In an example, each of the air pulse signals include 1 second time delay, 1 Hz pulses at a 10 meter depth. In another example, each of the air pulse signals include 1 second time delay, 1 Hz pulses at a 130 meter depth. In yet another example, each of the air pulse signals include 2 second time delay, 0.5 Hz pulses at a 10 meter depth or at a 130 meter depth. While the embodiments of the system 700 described with respect to FIG. 7 include 3 seismic sources 700(1)-(3), more or fewer sources such as airguns may be included without departing from the scope of the disclosure. For example, the system 700 may include 4, 5, 6, or more seismic sources. Using multiple seismic sources pulsed at constant intervals may synthesize an extended time delay between pulses and bypass a bubble period derived from the Rayleigh-Willis formula. This may provide modulated pulses on top of (e.g., or convolved with) pulses of a single gun spectrum.

In some examples, a first of the seismic sources 700(1)-(3) may emit seismic energy by generation of a first air bubble into the seismic medium at a first time, a second of the seismic sources 700(1)-(3) may emit seismic energy by generation of a second air bubble into the seismic medium at a second time after the first time, and a third of the seismic sources 700(1)-(3) may emit seismic energy by generation of a third air bubble into the seismic medium at a third time after the second time. The seismic energy may have a low frequency characteristic (e.g., have a frequency that is less than a predefined frequency). The first, second, and third air bubbles may be spaced apart without frequency locking, while generating the seismic energy in the seismic medium. In some examples, the first, second, and third air bubbles may form a seismic wavefield. In some examples, a time period between the first time, the second time, and the third time may be selected based on the predefined distance, the seismic medium, and a volume of the first, second, and third air bubbles. A predefined distance and/or the time period between the seismic sources 700(1)-(3) may be selected to reduce ghosting effects or zero-hertz notch in the seismic wavefield. The predefined distance, the time period, and the low frequency characteristic may all selected based on one or more of charge pressure P0, gun volume V, and operation of the source at a selected depth.

### Examples

Example 1 is a system that includes a first seismic source configured to emit seismic energy by generation of a first air bubble into the seismic medium at a first time, and a second seismic source spaced a predefined distance from the first seismic source and is configured to emit seismic energy by generation of a second air bubble into the seismic medium at a second time after the first time. The seismic energy has a low frequency characteristic.

In Example 2, the subject matter of Example 1 further includes that the first air bubble is spaced from the second air bubble without frequency locking, while generating the seismic energy in the seismic medium.

In Example 3, the subject matter of Examples 1-2 further includes that the first air bubble and the second air bubble form a seismic wavefield.

In Example 4, the subject matter of Examples 1-3 further includes that a time period between the first time and the second time is selected based on the predefined distance, the seismic medium, and a volume of the first and second air bubbles.

In Example 5, the subject matter of Examples 1-4 further includes that the low frequency characteristic is a frequency that is less than a predefined frequency.

In Example 6, the subject matter of Examples 1-5 further includes that the seismic medium is a water column.

In Example 7, the subject matter of Examples 1-6 further includes a third seismic source spaced the predefined distance from the first seismic source and the second seismic source. The third seismic source is configured to emit seismic energy by generation of a third air bubble into the seismic medium at a third time after the second time.

In Example 8, the subject matter of Example 7 further includes that a time between the first time and the second time is equal to a time period and a time between the second time and the third time is equal to the time period.

In Example 9, the subject matter of Example 8 further includes that the first air bubble, the second air bubble, and the third air bubble form a seismic wavefield. The time period is selected to reduce ghosting effects in the seismic wavefield.

In Example 10, the subject matter of Examples 8-9 further includes that the predefined distance, the time period, and the low frequency characteristic are selected based on one or more of charge pressure P0, gun volume V, and operation of the source at a selected depth.

In Example 11, the subject matter of Examples 7-10 further includes that the first air bubble, the second air bubble, and the third air bubble form a seismic wavefield. The predefined distance, the time period, and the low frequency characteristic are selected to reduce zero-hertz notch effects in the seismic wavefield.

In Example 12, the subject matter of Examples 1-11 further includes that the predefined distance is selected to reduce ghosting effects in the seismic wavefield.

In Example 13, the subject matter of Examples 1-12 further includes that the first seismic source is configured to be deployed to a same depth within the seismic medium as the second seismic source.

Example 14 is a method, including: causing a first seismic source to emit seismic energy by generation of a first air bubble into the seismic medium in a first direction at a first time; and causing a second seismic source to emit seismic energy by generation of a second air bubble into the seismic medium in the first direction at a second time after the first time, wherein the second seismic source is spaced apart from the first seismic source a predefined distance, wherein the seismic energy has a low frequency characteristic.

In Example 15, the subject matter of Example 14 further includes that the first air bubble is spaced from the second air bubble without frequency locking, while generating the seismic energy in the seismic medium.

In Example 16, the subject matter of Examples 14-15 further includes that the first air bubble and the second air bubble form a seismic wavefield.

In Example 17, the subject matter of Example 16 further includes selecting the predefined distance between the first seismic source and the second seismic source to reduce ghosting effects in the seismic wavefield.

In Example 18, the subject matter of Examples 16-17 further includes selecting a time period between the first time and the second time, the predefined distance, and the low frequency characteristic to reduce ghosting effects in the seismic wavefield.

In Example 19, the subject matter of Examples 16-18 further includes selecting the predefined distance, a time period between the first time and the second time, and the low frequency characteristic to reduce zero-hertz notch effects in the seismic wavefield.

In Example 20, the subject matter of Examples 14-19 further includes delaying emission of the second air bubble from the second seismic source by a predefined time period from the first time to the second time. The time period is equal to a time difference between the first time and the second time.

In Example 21, the subject matter of Examples 14-20 further includes that the low frequency characteristic is a frequency that is less than a predefined frequency.

In Example 22, the subject matter of Examples 14-21 further includes that the seismic medium is a water column.

In Example 23, the subject matter of Examples 14-22 further includes causing a third seismic source to emit seismic energy by generation of a third air bubble into the seismic medium at a third time after the second time. The third seismic source is spaced at least the predefined distance from both the first seismic source and the second seismic source.

In Example 24, the subject matter of Examples 14-23 further includes gun volume V, and operation of the source at a selected depth.

In Example 25, the subject matter of Examples 14-24 further includes deploying the first and second seismic sources in the seismic medium at a specified depth.

Example 26 is at least one machine-readable medium including instructions that, when executed by processing circuitry, cause the processing circuitry to perform operations to implement of any of Examples 14-25.

While this disclosure is directed to representative embodiments, other examples may be encompassed without departing from the scope of invention, as determined by the claims. While the invention may be described with respect to particular exemplary embodiments, it is understood that changes can be made and equivalents may be substituted to adapt the disclosure to different problems and application, while remaining within the spirit and scope of the invention as claimed. The invention is not limited to the particular examples that are described, but encompasses all embodiments falling within the scope of the claims.

What is claimed is:

1. A system, comprising:
a first seismic source configured to emit seismic energy by generation of a first air bubble into the seismic medium at a first time; and
a second seismic source spaced a predefined distance from the first seismic source, the second seismic source configured to emit seismic energy by generation of a second air bubble into the seismic medium at a second time after the first time, wherein the seismic energy has a low frequency characteristic.

2. The apparatus of claim 1, wherein the first air bubble is spaced from the second air bubble without frequency locking, while generating the seismic energy in the seismic medium.

3. The system of claim 1, wherein the first air bubble and the second air bubble form a seismic wavefield.

4. The system of claim 1, wherein a time period between the first time and the second time is selected based on the predefined distance, the seismic medium, and a volume of the first and second air bubbles.

5. The system of claim 1, wherein the low frequency characteristic is a frequency that is less than a predefined frequency.

6. The system of claim 1, wherein the seismic medium is a water column.

7. The system of claim 1, further comprising a third seismic source spaced the predefined distance from the first seismic source and the second seismic source, the third seismic source configured to emit seismic energy by generation of a third air bubble into the seismic medium at a third time after the second time.

8. The system of claim 7, wherein a time between the first time and the second time is equal to a time period, wherein a time between the second time and the third time is equal to the time period.

9. The system of claim 8, wherein the first air bubble, the second air bubble, and the third air bubble form a seismic wavefield, wherein the time period is selected to reduce ghosting effects in the seismic wavefield.

10. The system of claim 8, wherein the predefined distance, the time period, and the low frequency characteristic are selected based on one or more of charge pressure P0, gun volume V, and operation of the source at a selected depth.

11. The system of claim 7, wherein the first air bubble, the second air bubble, and the third air bubble form a seismic wavefield, wherein the predefined distance, the time period, and the low frequency characteristic are selected to reduce zero-hertz notch effects in the seismic wavefield.

12. The system of claim 1, wherein the predefined distance is selected to reduce ghosting effects in the seismic wavefield.

13. The system of claim 1, wherein the first seismic source is configured to be deployed to a same depth within the seismic medium as the second seismic source.

14. A method, comprising:
causing a first seismic source to emit seismic energy by generation of a first air bubble into the seismic medium in a first direction at a first time; and
causing a second seismic source to emit seismic energy by generation of a second air bubble into the seismic medium in the first direction at a second time after the first time, wherein the second seismic source is spaced apart from the first seismic source a predefined distance, wherein the seismic energy has a low frequency characteristic.

15. The method of claim 14, wherein the first air bubble is spaced from the second air bubble without frequency locking, while generating the seismic energy in the seismic medium.

16. The method of claim 14, wherein the first air bubble and the second air bubble form a seismic wavefield.

17. The method of claim 16, further comprising selecting the predefined distance between the first seismic source and the second seismic source to reduce ghosting effects in the seismic wavefield.

18. The method of claim 16, further comprising selecting a time period between the first time and the second time, the predefined distance, and the low frequency characteristic to reduce ghosting effects in the seismic wavefield.

19. The method of claim 16, further comprising selecting the predefined distance, a time period between the first time and the second time, and the low frequency characteristic to reduce zero-hertz notch effects in the seismic wavefield.

20. The method of claim 14, further comprising delaying emission of the second air bubble from the second seismic source by a predefined time period from the first time to the second time, wherein the time period is equal to a time difference between the first time and the second time.

21. The method of claim 14, wherein the low frequency characteristic is a frequency that is less than a predefined frequency.

22. The method of claim 14, wherein the seismic medium is a water column.

23. The method of claim 14, further comprising causing a third seismic source to emit seismic energy by generation of a third air bubble into the seismic medium at a third time after the second time, wherein the third seismic source is spaced at least the predefined distance from both the first seismic source and the second seismic source.

24. The method of claim 14, further comprising selecting the predefined distance, a time period between the first time and the second time, and the low frequency characteristic based on one or more of charge pressure P0, gun volume V, and operation of the source at a selected depth.

25. The method of claim 14, further comprising deploying the first and second seismic sources in the seismic medium at a specified depth.
